(19) United States
(12) Patent Application Publication
(10) Pub. No.: US 2005/0025349 A1
(43) Pub. Date: Feb. 3, 2005

(54) Flexible integration of software applications in a network environment

(76) Inventor: Matthew Crewe, Edinburgh (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/630,020

(22) Filed: Jul. 30, 2003

(51) Int. Cl. G06K 9/00; G06F 13/00

(52) U.S. Cl. 382/128; 719/328

(57) ABSTRACT

A software application for integration into a picture archiving and communications systems (PACS) network is described. The software application is provided as a single software component using model-view-controller software architecture. The software component's interface is used to expose predominantly only functional parts of a stand-alone version of the software application to a system integrator. The interface provides a set of user interface control parameters and a set of data handling parameters. These allow a PACS network provider to integrate the software application easily by generating a suitable graphical user interface for the application which can be configured to match the “look and feel” desired by the network provider. This can be done in a way which does not require the PACS network provider to have a deep understanding of the technical functioning of the software application.

### BACKGROUND OF THE INVENTION

The invention relates to integrating a medical-imaging software application into a network, in particular the invention relates to integrating a medical-imaging software application into a Picture Archiving and Communications Systems (PACS) network.

In the past, traditional medical imaging software applications have operated as stand-alone applications or loosely integrated independent applications. A typical medical imaging software application might be a three-dimensional (3D) visualization application for viewing and manipulating a data set comprising a series of tomographic image slices. A user wishing to employ this visualization application would invoke the application on a computer. Although the computer may be connected to a network, for example to allow remotely stored data to be retrieved or images to be displayed on a remote terminal, the application itself would be self-contained and operate independently of the network. This means, for example, that much of the overall appearance and functionality of the application is determined wholly by its author.

Some aspects of medical imaging software applications and associated networks have become standardized. For example, in adhering to a common data storage and transfer format, such as the Digital Imaging and Communications in Medicine (DICOM) format, differently authored applications are able to read and write data which are accessible to other applications. Similar network architectures, such as the Picture Archiving and Communication System (PACS) architecture, have been developed to allow more simple networking of devices such as imaging modalities, data storage devices and computers for running software applications. This has meant that flexible networks capable of running several different software applications have become possible. However, since traditional medical imaging software applications run independently of each other, there is a wide range of different user interfaces which have developed for different software applications. This has meant that one application on a PACS network can have a very different “look and feel” to another application, even though the two applications may be performing many common or related tasks, such as retrieving data from a file storage, or volume rendering an image to be displayed.

Historically an institution, such as a hospital, wishing to implement a digital image distribution system has generally built a network in a piece-wise manner, for example by separately buying in imaging modalities, a PACS system for data storage and distribution, a radiology information system (RIS) and specialized clinical application and visualization software packages. There is, however, a growing trend for single solution networking, storage, and image review. This has led to PACS network providers supplying and installing complete digital image distribution and interpretation systems.

A PACS network provider will generally desire to incorporate pre-existing medical imaging software applications rather than write their own. This is done by licensing software applications authored by third parties for integration into their single solution PACS network. This approach allows the PACS network provider to offer a single installation network which can adequately compete in functionality with existing piece-wise built networks, but without the PACS provider having to develop the expertise encapsulated in pre-existing tried-and-tested software applications, the functionality of which end users are already familiar, and trust as reliable.

However, difficulties with this approach arise due to the different sources of software application that a PACS network provider is licensing. Software applications will often come from different application providers, each one providing a user interface with a different “look and feel”. However, a PACS network provider will generally prefer his system to have a proprietary standard user interface configuration providing unitary appearance. Furthermore, in addition to the desire to provide a product of uniform appearance, there are further benefits to using a standardized user interface for all software applications. A PACS network with several different user interfaces requires end-users to become proficient with a number of different interfaces, even for performing similar or common tasks, such as searching for stored data. This not only requires more training, but can lead to possible misinterpretation of data. For example, if two image display applications rely on different image processing conventions, a user may easily become confused when using one or other application as to whether a displayed image is, for example, original or post-processed data.

Because of this, PACS network providers look to import the functionality of pre-existing software applications by licensing highly granular versions of existing applications. These granular versions comprise a large number of separate fundamental functional components. This allows the fundamental components of, for example, a 3D visualization application to be instantiated and controlled according to a PACS network providers preferred user interface, while maintaining the expertise and reliability encapsulated in the original software application. This approach allows different applications to be integrated in to a PACS network provider's system in a highly flexible manner. The granular components effectively act as a toolkit or a library to be used in building the PACS network provider's proprietary system.

The granular component approach allows a PACS network provider to fully integrate the underlying functionality of a pre-existing software application into a PACS network with the flexibility to modify or add to both the user interface and the functionality of the application. However, this full functionality and flexibility comes at a cost. Proper implementation and integration of the various functional features in the granular software application requires advanced knowledge of general programming in addition to an in-depth understanding of the underlying technology of the application, such as volume rendering of CT or MR modalities. This means a PACS network provider utilising the multi-component granular version of an application must devote significant engineering time to integrating the code comprising the different components into his code base. Furthermore, the integration must be performed by a highly skilled technical programmer. This not only leads to significant expense, but can be responsible for a significant fraction of the time taken to get a PACS network to market, and risks introducing coding errors not present in the well-tested stand-alone versions of applications.

The granular multi-component approach can also present problems for the author, or provider, of a software application. For example, an application provider will generally incur increased costs associated with providing PACS network providers with a level of support which is necessarily different to that offered to users of a stand-alone version of their application. There is also an increased risk to the application provider of the underlying technology of the application being open to reverse engineering due to increased transparency of the functional features of the application.

### SUMMARY OF THE INVENTION

According to a first aspect of the invention, there is provided a software component containing a medical-imaging visualization application, the software component operable to function as a model component in a model-view-controller software architecture, and having an interface having a set of user interface control parameters and a set of data handling parameters, the sets of parameters being chosen to allow flexible integration of the visualization application into a proprietary Picture Archiving and Communications Systems (PACS) network.

The data handling parameters may be Digital Imaging and Communication in Medicine (DICOM) format data handling parameters.

A single software component of this kind can be readily integrated into a PACS network without requiring the PACS network provider to be familiar with the underlying technical operation of the application. However, the application can nonetheless be integrated in a manner which allows the PACS network provider to design his own GUI for the application. Because the application is self-contained in a software component, all of its underlying technical functioning is hidden from the PACS network provider and he need only be aware of the sets of parameters, properties and commands, required for a PACS network to properly interact with the application. This is the typical level of understanding that a competent user of the application would have. Integrating the application into the PACS network becomes a much easier task, and one which can be achieved by a programmer without special knowledge of the application in a shorter period than has previously been possible. For example, a 3D visualization application which might previously have taken a year to integrate into a PACS network might be integrateable within a month.

The software component can be a sub-component of a pre-existing data visualization application.

The approach allows a provider of a pre-existing software application for stand-alone use to create a version of the software for integration into a PACS network with relatively little programming effort.

The software component can include a software wrapper, the software wrapper being configured to map the sets of parameters of the interface to parameters appropriate for the sub-component. The software component may also be wrapped to accommodate the use of different programming platforms of any given PACS network, for example C++ or JavaScript programming platforms.

The sub-component of the pre-existing software application may interact with other parts of application using parameters which are highly technical and related to the functioning of the application, the parameters having evolved while the software application was being developed by experts. Some of the functions and uses of these parameters may not be easy to understand for a general programmer tasked with integrating the application in a PACS network. However, by providing a software wrapper for mapping between parameters required by the sub-component and more conceptual interface control parameters to be accessed by the programmer when integrating the application, the task of the programmer can be made easier. For example, a programmer may be familiar with the concept of rotating an image by a particular angle, but he may not be familiar with the concept of defining elements in a rotation matrix operator. If the sub-component relies on the latter for defining a rotation, the software wrapper could be designed to generate a rotation matrix from a given rotation angle, this would avoid the programmer needing to become familiar with rotation matrices to include access to the rotation function in his GUI.

The user input parameters include, for example, any of: two-dimensional (2D) tool parameters, three-dimensional (3D) tool parameters, sculpting parameters, display decoration parameters, preset parameters, region of interest select parameters, volume rendering parameters and image display parameters.

These are the kind of parameters which might typically be required to configure a GUI to allow proper manipulation and viewing of data in a visualization software application.

According to a second aspect of the invention, there is provided a PACS network including a software component containing a medical-imaging visualization application, the software component operable to function as a model component in a model-view-controller software architecture, and having an interface having a set of user interface control parameters and a set of data handling parameters, the sets of parameters being chosen to allow flexible integration of the visualization application into the PACS network. As with the first aspect of the invention, the data handling parameters may be DICOM format data handling parameters.

The PACS network may include a specific glue bridge software component, the specific glue bridge being operable to accommodate non-standard aspects of the PACS network.

The non-standard aspects may, for example, relate to non-standard data formats, such as compressed data formats, or non-standard data handling aspects, such as proprietary schemes for grouping data.

By employing a specific glue bridge software component, it is not necessary for the software component containing the application to be modified in response to different PACS provider's departures from generally accepted software practices of medical imaging, for example the use of the DICOM standard as an image format. This ensures that an application provider has only to maintain a single version of the software component containing his application and so assists version control, and consistency of functionality between different installations.

The PACS network may also include a dispatcher software component, the dispatcher being operable to link multiple software components corresponding to multiple software applications to the PACS network via a common interface.

This simplifies the integration of multiple software applications into a PACS network since the PACS network provider need write only one view and one controller software component for defining his GUI.

According to a third aspect of the invention, there is provided a method of offering a medical-imaging data visualization application to a PACS network integrator, the method comprising:
providing a first version of the application contained in a high-level software component;
providing a second version of the application contained in a plurality of lower-level software components; and
allowing the integrator to decide between use of the different versions for integrating the application into a PACS network.

This approach allows the application provider to meet a range of different market requirements while maintaining a single software application. A PACS provider who is satisfied with a relatively modest standard set of functionality options for the application software, or who needs to have a working product with minimum design effort, would implement using the first version of the application, since this maximises ease of integration. On the other hand, a PACS provider who wishes to modify the functionality of the application software beyond what is possible with the standard options would implement using the second version since this allows him to alter the underlying technical functionality of the software. This model would also allow a PACS provider to easily move integration from high-level component integration to lower level component integration as their relationship with the component provider and knowledge of the application and underlying functionality increases, thus providing a more gradual learning curve for increased flexibility.

The high-level software component is preferably operable to function as a model component in a model-view-controller software architecture, and has an interface having a set of user interface control parameters and a set of data handling parameters. The data handling parameters may be DICOM format data handling parameters.

At least a subset of the lower-level software components preferably relate to underlying technical functions of the application.

It is also possible to provide a third version of the application contained in a plurality of intermediate-level software components. The application is then offered in high, intermediate and lower levels to allow integration at each of three different levels. Further versions of the application contained in a plurality of software components at other levels can also be provided.

### BRIEF DESCRIPTION OF THE DRAWINGS

For a better understanding of the invention and to show how the same may be carried into effect reference is now made by way of example to the accompanying drawings in which:

FIG. 1 is a schematic diagram showing an example PACS network comprising a number of imaging modalities and workstations, a file server and archive and a software application server according to a first embodiment of the invention.

FIG. 2 is a diagram schematically showing a software application integrated into the PACS network of FIG. 1;

FIG. 3 is a diagram schematically showing four separate software applications integrated into the PACS network of FIG. 1;

FIG. 4 is a diagram schematically showing a software application integrated into a PACS network according to a second embodiment of the invention;

FIG. 5 is a diagram schematically showing three separate software applications integrated into a PACS network according to a third embodiment of the invention; and

FIG. 6 is a diagram which schematically shows the trade-off which must be made between ease and speed of integration and level of available functional flexibility when integrating a software application into a PACS network.

### DETAILED DESCRIPTION

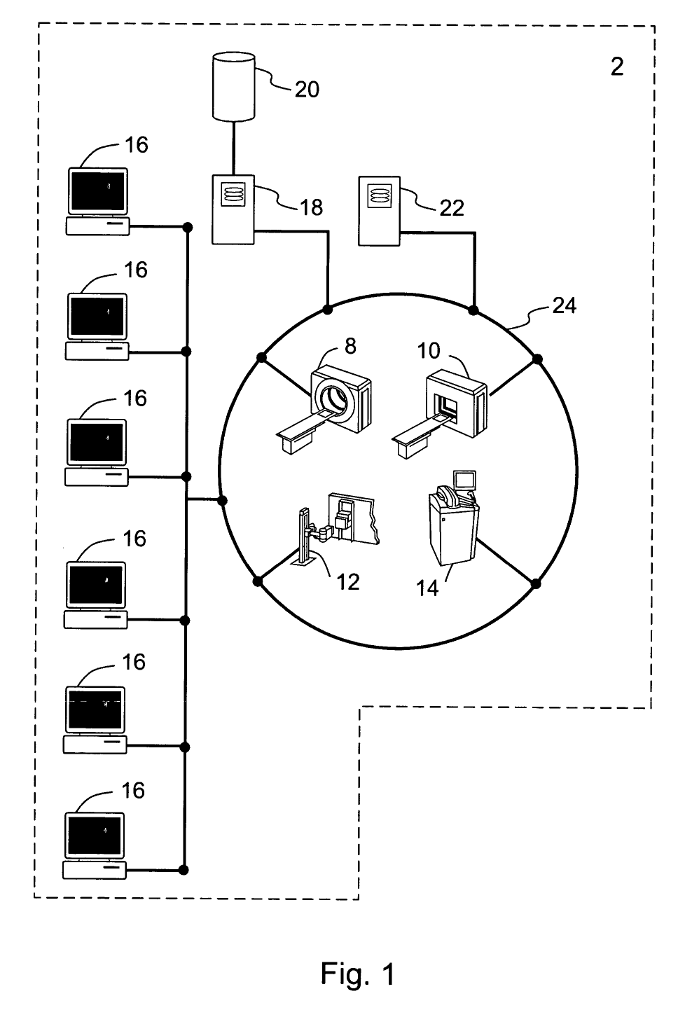

FIG. 1 is a schematic representation of a PACS network 2 supplied to a hospital by a PACS network provider as a unitary PACS installation. The PACS network interfaces with a plurality of imaging modalities, in this example, a CT scanner 8, a MR imager 10, a DR device 12 and a CR device 14, a plurality of computer workstations 16, a file server 18 and file archive 20 and an application server 22. All of the features of the network are inter-connected by a local area network (LAN) 24.

In typical operation, one of the imaging modalities, for example, the CT scanner 8, generates a source data set, i.e. a 3D image data set, from which an operator may derive a series of two-dimensional (2D) images. The images are encoded according to the DICOM standard and transferred over the LAN 24 to the file server 18 for storage in the file archive 20. A user at one of the computer workstations 16 wishing to view the data invokes a software application appropriate to the data he wishes to view, in this case CT data, and the task he wishes to perform, e.g. 3D visualization. The software application is accessed through a GUI displayed on the workstation 16, coupled with conventional input peripherals, such as a mouse and keyboard (not shown), to allow the user to retrieve data from the file archive, to manipulate data according to the function of the application, and to view resultant images. While in this example the software application operates from a central application server, it will be appreciated that applications may equally be stored on any of the workstations of the network. Similarly, applications may be stored on a central application server but run within the processor of a workstation at which a user is working.

The PACS network of FIG. 1 differs from conventional PACS networks by the manner in which the functionality of pre-existing software applications is integrated in to the network. In contrast to conventionally supplied pre-existing software applications, an application for the PACS network shown in FIG. 1 is supplied as a small number of high-level components, and not as a library of many components each related to specific, often low-level, functions of the volume rendering process. In one embodiment, the application is provided as a single software component, for example the visualization component of an otherwise stand-alone 3D visualization application, and integrated into the PACS network in a manner consistent with the model-view-controller software architecture. In this scheme, the application provider supplies the model as a self-contained software component. The PACS network provider is then free to design controller and view components consistent with the “look and feel” of his PACS network. The freedom of the PACS network provider is limited only by the need for the controller and view components to be capable of interacting appropriately with the model component (i.e. with the functionality of the software application). For example, while the PACS network provider is able to determine which aspects of the model component are accessible to a user, he cannot add more aspects by simply providing for them in his controller if the model component cannot support the corresponding functionality.

Unlike previous integration schemes, with the model-view-controller approach of the invention, the fundamental underlying technical aspects of an application's functionality are hidden from a PACS network provider, but the network provider is nonetheless free to design his own user interface through his defined controller and view components. This means the PACS network provider can quickly generate a proprietary GUI for interacting with the third-party-supplied software component which encompasses all, or any subset of, the functionality of a stand-alone version of the third-party application. The approach means the application provider does not have to release a low-level version of his application making it more amenable to reverse engineering yet allows the PACS network provider to fully integrate the third-party application in to his network with a user interface consistent with the “look and feel” of his system. This can be done more quickly and with less technical effort than that required to integrate a granular component version of the application. With a single software component model-view-controller approach, the PACS network provider can decide which functions of the third party application a user can perform on data being visualised, for example rotations or window and level manipulation for volume rendering, and how the user interface appears, but he cannot alter the fundamental aspects of the functionality of the application, such as use of the algorithms which govern the rotation or rendering.

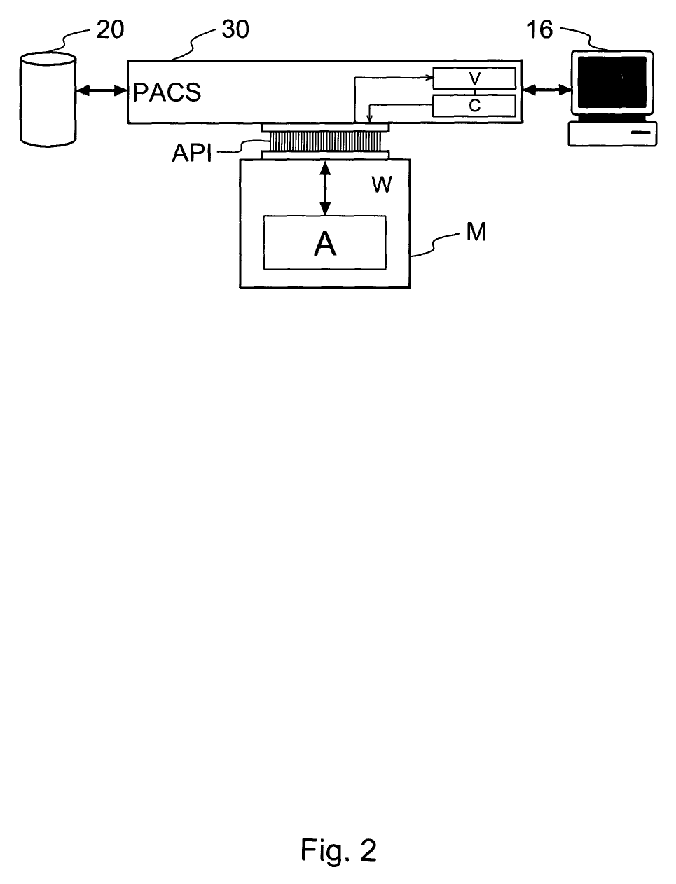

FIG. 2 schematically shows how a pre-existing 3D visualization application is integrated into the PACS network 2 of FIG. 1. In FIG. 2, all except the file archive 20, one of the workstations 16 and a schematic representation of a model software component M providing the functionality of the application, an interface API and a software wrapper W, are grouped into a single main PACS element 30 for simplicity. Also shown in the main PACS element are schematic representation of the view software component V and the controller software component C of the model-view-controller architecture.

Functional software A, which contains all of the visualization functionality of a stand-alone version of the 3D visualization application, is supplied by the application provider. If the application provider's stand-alone version of the software rigorously follows a model-view-controller software architecture, the model component of the stand-alone application can be supplied directly as a software component to the PACS network provider without modification. However, for the visualization application shown in FIG. 2 this is not the case, and the application is supplied as functional software A in a software wrapper W which together comprise the software component provided by the application provider. The software wrapper W is responsible for ensuring the functional software appears to the PACS network as a single self-contained model component M, consistent with the model-view-controller paradigm. The software wrapper W can also be augmented to conform to the specific programming platform of the PACS network. The model component M comprising the software application is stored and made accessible to the PACS network in a conventional manner. While in the example shown in FIG. 2, the model component M is schematically represented separately from the remainder of the PACS network, in general it will be stored on either the application server 22 shown in FIG. 1, or one of the workstations 16.

When a user invokes an application provided by the PACS network provider in order to view or analyse data, the user is presented with a user interface defined by the view and controller components authored by the PACS network provider. The model component of the application, i.e. that part which performs the functionality of the application, mirrors the behavior of the stand-alone version of the application in a manner which is transparent to the user. Instructions received from (and information displayed to) the user are passed to (and received from) the model component in a manner determined by the view (and controller) components designed by the PACS network provider.

The model component M communicates with the controller C and view V components via an application programming interface (API) defining a number of interface parameters. The defined interface parameters are the parameters necessary to allow the model to interact with the user, and to allow the user to access the functionality of the model, that is to allow the model to receive instructions from the controller component and pass information to the view component. In addition, the interface allows the model to properly interact with the PACS network to perform other functions, such as to read data from the file archive.

Conventionally, an API is designed by considering what technical functions the associated software component provides, and devising an appropriate interface that provides full control of these functions. In complex applications, such as in medical imaging applications, this can mean a resultant API becomes highly specialised and mathematical. For example, rotating a displayed image might require setting parameters in a rotation matrix in response to a user instruction. Since in a stand-alone version of the application, it is the application provider who writes the user interface, a technically complex API does not present a major concern. However, even with a single component integration approach of the kind discussed above, the PACS network provider may need to understand the functionality of the application at a relatively deep level to be able to design appropriate view and controller components. To reduce the level of understanding required by a PACS provider integrating the single model component of an application further still, an API can be designed by considering the user-visible controls and operations that a typical application might have. The user-centred design approach would not expose all of the technical functionality the application is able to provide, but would provide API functions that map to user-level concepts, such as GUI buttons, computer mouse activity and keyboard input. For example, the API may be designed to include functions which require conceptually simple input parameters such as Euler angles for defining a rotation, these angles can then be mapped to the parameters in the rotation matrix in a manner which is hidden from the user. The mapping may be provided by the software wrapper W shown in FIG. 2. This means that API functions can be designed which map to standard GUI building blocks so that a PACS provider's task of designing a GUI to interact with the functional model component can be accomplished without detailed mathematical or computer graphics knowledge.

Parameters for the API include both user input control parameters and data handling parameters. A PACS network provider's task when integrating the application into his network becomes one of writing view and controller components which set and respond to these parameters in a way appropriate to the desired “look and feel” and functionality of his system.

In the example 3D visualization application, the set of input control parameters may include parameters such as the following. Property and command parameters for defining a GUI appearance, for example its display colours, control locations, locations and formats of information displayed to, or received from, the user. Parameters for generating an image to be displayed, such as parameters for selecting a region of interest or sculpting parameters. Parameters for setting the appearance of a displayed image, such as brightness, contrast, opacity, window levels and volume rendering characteristics. Parameters for manipulating a displayed image, such as panning, zooming and rotating. In a typical complex application there may be several thousand parameters for defining the interaction of the model with the view and the controller.

A PACS network provider is free to design his view and controller to set initial or default values for these parameters when a user invokes the application, and also to determine how a user is able to modify parameters. For example, different PACS network provider may prefer different default view angles when an application is invoked. To set their preferred view angle, a PACS network provider need only ensure that his controller component sets appropriate parameters in the interface when the application is first invoked. Similarly, a PACS network provider can allow a user to modify, for example, the magnification of a displayed image via either a GUI control slider, a numeric keyboard entry or in response to movement of a computer mouse. The PACS network provider is free to decide which of these input means to use, so long as his controller component sets the appropriate user interface control parameter(s) defining the magnification of the displayed image.

The data handling parameters are those parameters required to allow the model component to correctly read data from the PACS network, for example from the file archive or directly from an imaging modality, and to correctly write data to the PACS network, for example to the file archive or to another software application. In addition, the data handling parameters may also provide for defining different data transfer mechanisms to be employed during data transfer between the PACS network and the model component. For example, in the interface for the model component shown in FIG. 2, parameters can be set to determine whether the PACS network loads data to and from the model component synchronously or asynchronously.

Further parameters can be set to determine whether data are to be read from the PACS network in a one-stage or two-stage process, described further below. The most commonly used data file format used in PACS systems is the DICOM format. This format requires that in addition to image data, image files should contain a header portion containing information about the image. The header portion can contain, for example, detail of the image type, image size, patient details and whether the image forms part of a series of images, such as one slice in a multi-slice grouping. A model component may read each entire DICOM file from the network in a one-stage process. The header data and image data are both transferred to the model component. The model component then parses the header information to extract information necessary for it to perform a required function, for example, to determine the position of a 2D image slice in a multi-slice group. In other examples, however, the model component may read the DICOM files from the network in a two-stage process, in a first stage the header information are read, and in a second stage, the image data are read. A benefit of transferring DICOM files this way is that header data can quickly be transferred, and parsed by the model component without having to transfer the bulk of the DICOM file. This would allow, for example, the model component to check whether it has access to sufficient memory resources to load the requested image data. If the image files are too big, action can be taken before network bandwidth is unnecessarily taken up by transferring image data which cannot be used. Appropriate action might include, for example, ceasing data transfer and referring the issue back to the user, or perhaps only loading every other image in a multi-slice image.

Data handling parameters can also be defined to allow functions which are normally performed by the model component to be switched off. For example, a common task for a model component is to group a series of individual image slices of a multi-slice image into a single data set for subsequent visualization. The grouping process must adhere to certain rules to ensure a user is not confused by inappropriately grouped slices. These can be simple rules, such as ensuring the images are of the same patient, or more complex rules such as determining whether the image slices are evenly spaced to within a given tolerance. If a series of images cannot be grouped according to these rules, for example because it comprises a mixture of images from different patients, the model component returns an error. However, different PACS network providers may wish to rely on different grouping rules. This can be addressed by allowing the PACS network provider to pre-group image slices according to its own rules using a pre-grouping software component, and setting a data handling parameter to instruct the model component to trust this grouping, and not to attempt to group the images itself.

Other data handling parameters defined in the interface can be used to activate additional features of the data transfer mechanism. For example, a pre-load parameter can be set to configure the model application to perform speculative loading of data under certain circumstances, e.g. to pre-load a 3D image data set when a corresponding 2D image data set is being viewed by a user. This might be appropriate for a PACS network with limited bandwidth which is largely available to a single user. On many occasions a user viewing a 2D image data set may wish to subsequently view a corresponding 3D data set, speculative loading of the 3D data set while the network is otherwise idle can therefore minimise time spent by the user waiting for data to transfer when he requests it. However, in another PACS network, bandwidth may be shared between several users. This can mean that it might be inappropriate to pre-load data for one user while he is not otherwise using bandwidth since this can interfere with the data transfer requirements of other users. In such a circumstance the PACS network provider can set the pre-load parameter to not allow pre-loading, or set a range of parameters to limit the situations in which pre-loading is allowed to occur, for example to situations where there is a high chance that the pre-loaded data will be required.

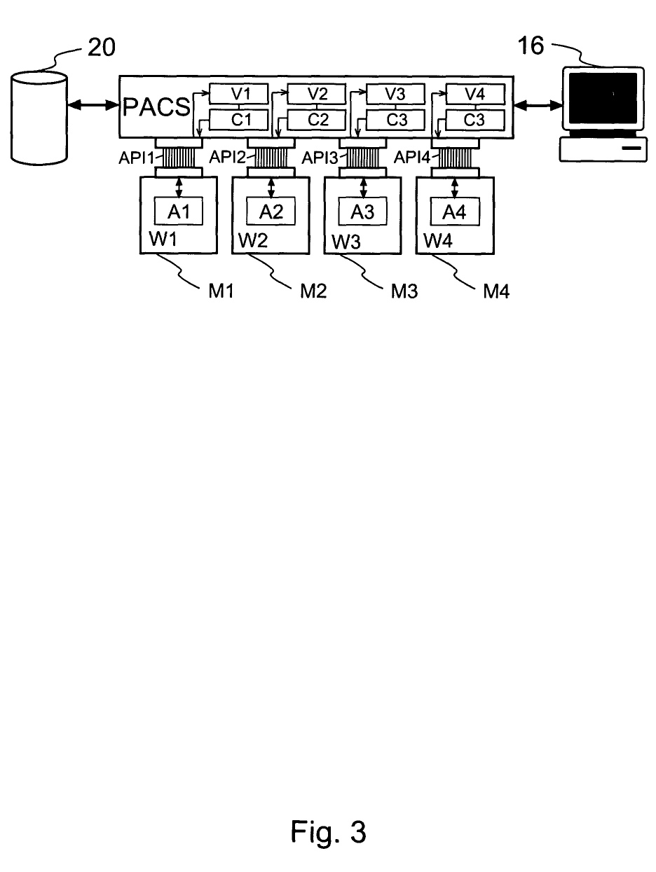

FIG. 3 schematically shows how a number of different pre-existing software applications are integrated into the PACS network of FIG. 1. Many of the features of FIG. 3 are similar to and will be understood from the corresponding features of FIG. 2. However, instead of the single model component M shown in FIG. 2, four different model components M1-M4 are shown. Each model component corresponds to a separate software application A1-A3 provided by either the same or different application providers. Each of these is integrated independently into the PACS network in accordance with the scheme described above. As can be seen from FIG. 3, each model component M1-M4 has a corresponding view component V1-V4, controller component C1-C4 and interface API1-API4. In general the different functionality of the different model components will mean that each interface will be different, though some interface parameters may be common to them all. As described above, the PACS provider can design the respective view and controllers components to provide a common “look and feel” to the four applications contained in the four model components.

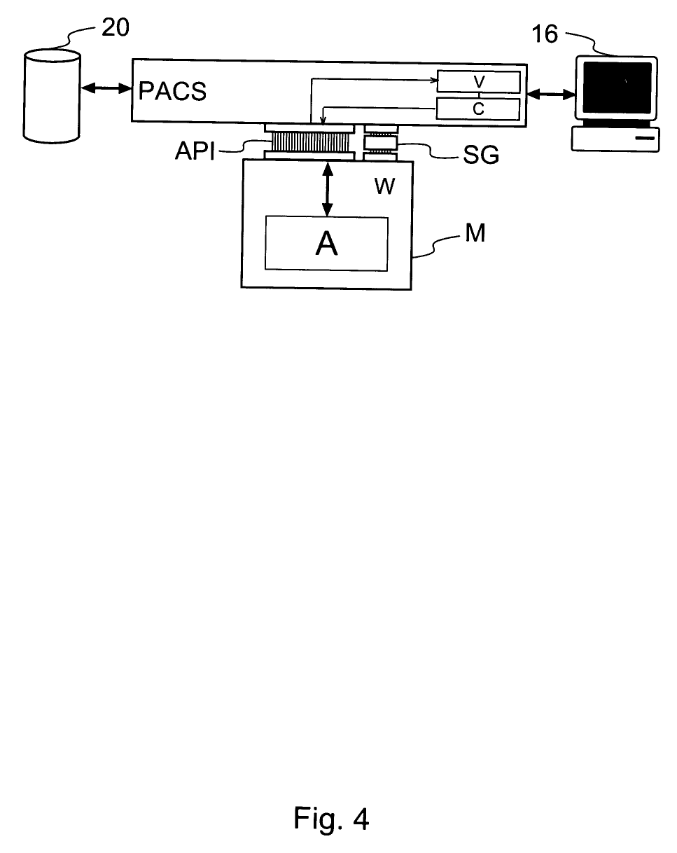

FIG. 4 schematically shows how a pre-existing 3D visualization application can be integrated into a PACS network similar to that of FIG. 2, but which differs from generally accepted software practices of medical imaging, for example the use of the DICOM standard as an image format, according to a second embodiment of the invention. It is not uncommon for PACS network providers to depart from generally accepted software practices in implementations of a PACS network. For example, a PACS provider may employ a proprietary data compression algorithm for storing data. This can make it difficult for an application provider to supply a generic model component which can be integrated into all PACS networks in accordance with the schemes described above. However, there are several benefits associated with having to maintain only a single model component, for example ease of maintenance and guaranteed functional consistency across different implementations. This means it is not generally desirable for an application provider to tune a model component to suit different PACS providers. As shown in FIG. 4, this problem can be addressed by the inclusion of a specific-glue bridge SG. The other features of FIG. 4 are similar to and will be understood from the corresponding features of FIG. 2. The specific glue bridge comprises logic operable to deal with inconsistencies in a particular PACS network provider's implementation. For example, in the case that the PACS network provider employs a proprietary data compression algorithm, the specific glue bridge would be designed to implement this algorithm. The specific glue bridge would decompress data as it is read from the network by the model component, and similarly compress data as it is written to the network by the model component. This approach means that an application provider is able to supply a generic model component encapsulating the functionality of his application to all PACS network providers, and need only write a specific glue bridge for each network provider to accommodate any non-conformant aspects of their network.

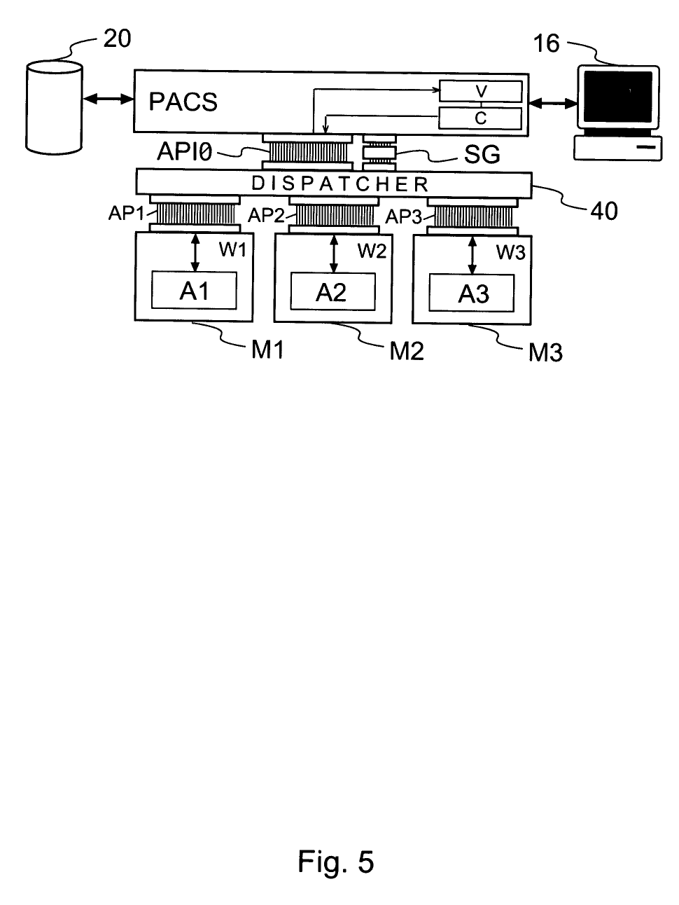

FIG. 5 schematically shows a way in which a number of different pre-existing software applications can be integrated into a PACS network according to a third embodiment of the invention. Many of the features of FIG. 5 are similar to and will be understood from the corresponding features of FIG. 3. However, whereas in the scheme shown in FIG. 3 the different model components are independently integrated into the PACS network, in the scheme shown in FIG. 5, the different model components M1-M3 are integrated via a dispatcher 40. The PACS network includes a single controller component C and a single view component V. A user wishing to perform a particular function on a particular type of data selects which of the model components to invoke. In an alternative scheme, a user simply identifies which data he wishes to view, and the dispatcher is configured to invoke the most appropriate model component, for example based on which imaging modality created the data, whether the data represent a 2D or 3D image, what anatomy and/or pathology is contained in the data, and so on. Whichever model component is invoked, the user is presented with the same user interface, as defined by the view and controller components. The dispatcher is responsible for intercepting instructions from the controller component C of the PACS network and routing them to the appropriate one of the model components M1-M3 by appropriate setting of parameters in the interfaces API1-API3. The dispatcher is also responsible for receiving display information from the relevant model component and passing it to the view component of the PACS network. In effect, the dispatcher provides an intermediate level between the different model components and the PACS network such that the multiple model components appear to the PACS network as a single component with all of the functionality of the individual model components M1-M3. This means that a PACS network provider can integrate several model components corresponding to different software applications while needing to design only a single view component and a single controller component.

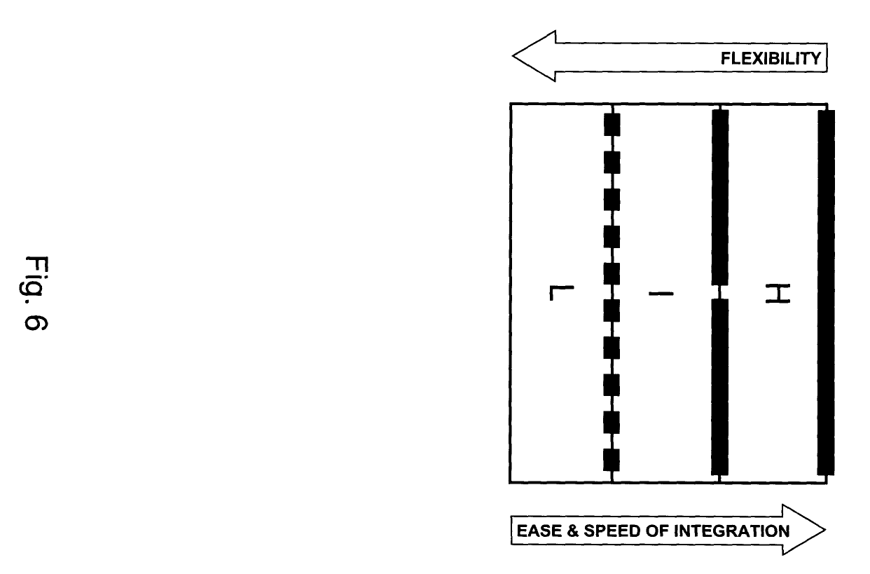

FIG. 6 schematically shows the trade-off which must be made between ease of integration and level of functional flexibility available when integrating a software application into a PACS network. In the figure, ease and speed of integration is shown increasing upwardly, as indicated by the arrow on the right-hand side of the figure, and level of functional flexibility is shown increasing downwardly, as indicated by the arrow on the left, as a function of the level of software components used for the integration. A software application can be broken into different levels. It can be broken into a small number of high level components, an intermediate number of intermediate level components or a large number of low-level components. In FIG. 6 the level of software components used in the integration increases upwardly. Areas marked H, I, and L correspond to high-, intermediate- and low-level components respectively. As can be seen from FIG. 6, the use of high-level software components corresponds to a high ease of integration, though with a correspondingly lower level of functional flexibility.

In the above description, a single high-level software component is employed. This is schematically indicated in FIG. 6 by a single horizontal bar at the top of the region marked H. As seen above, this extreme of high-level integration can be integrated into a PACS network with little effort on the part of the PACS network provider. Furthermore, the above described scheme allows this ease of integration to be achieved while still providing for a flexible user interface to be designed by the PACS network provider. However, as can be seen from FIG. 6, the approach of employing a single high-level software component does not allow much functional flexibility. This means that although the PACS network provider has a great deal of flexibility in designing the user interface, he has little opportunity to modify the functional aspects of the application he is integrating. Depending on the desired modifications, an application provider may choose to respond to requests from a PACS network provider to modify or add to the functionality of his application by including it into the single software component he supplies to all PACS network providers. However, in other circumstances, a PACS network provider may wish to modify an application to such an extent that the application provider is not willing to implement the changes into his single component version, or the PACS network provider himself may wish to maintain secrecy regarding his particular installation of the software application.

In order to address this, the application provider may offer two or more versions of his software application to PACS network providers. A first version is the high-level single software component version described above, and which provides the maximum ease of installation with a flexible user interface. The application provider may also offer a low-level of software component to act as a toolkit of library for PACS network providers requiring high levels of control over functionality. The application provider may also offer a version comprising an intermediate level of software component. This version might comprise, for example, four separate components, as schematically indicated by the four horizontal bars at the top of the region marked I. This version is not as easy to integrate as the first version since it requires the PACS network provider to comprehend the manner in which the four components interact. However, the PACS network provider is able to modify the way these components interact to provide additional functionality.

As an example, a 3D visualization application might be offered as a single self-contained software component and also as four separate intermediate level software components. These might be a first component responsible for importing data from a PACS network, a second component responsible for initial manipulation of the data, for example filtering and grouping, a third component responsible for generating a representation of the data, for example rendering and setting contrast and brightness levels, and a fourth component responsible for manipulating the displayed image, for example performing rotation or zoom actions. In the single software component version, the PACS network provider has limited scope for altering the functional aspects of the application. However, with the four component version there is scope for, for example, the PACS network provider incorporating a proprietary filtering algorithm. This can be achieved by including a new component which takes data from the first component, applies the proprietary filtering algorithm, and passes the data to the second component. Similarly, the PACS network provider may supply his own version of one of the components, but rely on the application provider's version of the other components. This multi-level component approach allows the application provider to meet a range of different market requirements while maintaining a single software application.

It will be appreciated that although particular embodiments of the invention have been described, many modifications/additions and/or substitutions may be made within the spirit and scope of the present invention.

1. A software component containing a medical-imaging visualization application, the software component operable to function as a model component in a model-view-controller software architecture, and having an interface having a set of user interface control parameters and a set of data handling parameters, the sets of parameters being chosen to allow flexible integration of the visualization application into a proprietary Picture Archiving and Communications Systems (PACS) network.

2. A software component according to claim 1, wherein the data handling parameters are Digital Imaging and Communications in Medicine (DICOM) format data handling parameters.

3. A software component according to claim 1, wherein the software component is a sub-component of a pre-existing data visualization application.

4. A software component according to claim 3, wherein the software component includes a software wrapper, the software wrapper being configured to map the sets of parameters of the interface to parameters appropriate for the sub-component.

5. A software component according to claim 1, wherein the user input parameters include any of: two-dimensional (2D) tool parameters, three-dimensional (3D) tool parameters, sculpting parameters, display decoration parameters, preset parameters, region of interest select parameters, volume rendering parameters and image display parameters.

6. A PACS network including a software component containing a medical-imaging visualization application, the software component operable to function as a model component in a model-view-controller software architecture, and having an interface having a set of user interface control parameters and a set of data handling parameters, the sets of parameters being chosen to allow flexible integration of the visualization application into the PACS network.

7. A PACS network according to claim 6, wherein the data handling parameters are DICOM format data handling parameters.

8. A PACS network according to claim 6, the PACS network including a specific glue bridge software component, the specific glue bridge being operable to accommodate non-standard aspects of the PACS network.

9. A PACS network according to claim 8, wherein the non-standard aspects of the PACS network include a non-standard data format.

10. A PACS network according to claim 9, wherein the non-standard data format is a compressed data format.

11. A PACS network according to claim 8, wherein the non-standard aspects of the PACS network include non-standard data handling.

12. A PACS network according to claim 11, wherein the non-standard data handling relates to proprietary grouping of data.

13. A PACS network according to claim 6, the PACS network including a dispatcher software component, the dispatcher being operable to link multiple software components corresponding to multiple software applications to the PACS network via a common interface.

14. A method of offering a medical-imaging data visualization application to a PACS network integrator, the method comprising:
providing a first version of the application contained in a high-level software component;
providing a second version of the application contained in a plurality of lower-level software components; and
allowing the integrator to decide between use of the different versions for integrating the application into a PACS network.

15. A method according to claim 14, wherein the high-level software component is operable to function as a model component in a model-view-controller software architecture, and has an interface having a set of user interface control parameters and a set of data handling parameters.

16. A method according to claim 15, wherein the data handling parameters are DICOM format data handling parameters.

17. A method according to claim 14, wherein at least a subset of the lower-level software components relate to underlying technical functions of the application.

18. A method according to claim 14, further comprising:
providing a third version of the application contained in a plurality of intermediate-level software components.

19. A method according to claim 18, further comprising:
providing at least a fourth version of the application contained in a plurality of software components of a different level.
